(19) United States
(12) Patent Application Publication
(10) Pub. No.: US 2026/0277036 A1
(43) Pub. Date: Sep. 17, 2026

(54) METHOD FOR MANUFACTURING AN INTEGRATED ELECTRO-OPTICAL DEVICE, AND ELECTRO-OPTICAL DEVICE THUS OBTAINED

(71) Applicant: EXAIL, SAINT-GERMAN-EN-LAYE (FR)

(72) Inventors: Jérôme HAUDEN, SAINT-GERMAIN-EN-LAYE (FR); Anne-Laure POINTEL, SAINT-GERMAIN-EN-LAYE (FR); Hadj ACHOUKHI, SAINT-GERMAIN-EN-LAYE (FR)

(21) Appl. No.: 19/168,541

(22) PCT Filed: Mar. 28, 2024
(86) PCT No.: PCT/EP2024/058619

§ 371 Date: Sep. 24, 2025

(30) Foreign Application Priority Data
Mar. 29, 2023 (FR) FR2303050

(51) Int. Cl. G02F 1/03; G02F 1/21; G02F 1/225

(52) U.S. Cl. CPC G02F 1/0316; G02F 1/212; G02F 1/225

(57) ABSTRACT

The present invention relates to a method for manufacturing an electro-optical device (50) comprising the steps of manufacturing an optical waveguide (5) in an electro-optical substrate (1) by annealed proton exchange, comprising: a) exposing an area of a surface (2) of the substrate (1) to a proton source so as to create a layer (3) modified by proton exchange; and b) thermally annealing the substrate so as to create an optical waveguide (5) in a diffusion area (4) and depositing a pair of electrodes (6, 7), the optical waveguide (5) extending longitudinally between the pair of electrodes (6, 7). According to the invention, the method comprises, after the thermal annealing step, a step of machining a residue of the layer (3) in order to form a machined area (10, 11, 12) located at least partially between the pair of electrodes (6, 7).

### TECHNICAL FIELD OF THE INVENTION

The present invention relates to the technical field of electro-optical devices and their manufacturing methods.

More particularly, it relates to a method for manufacturing an electro-optical device integrated on an electro-optical substrate.

The invention also relates to an integrated electro-optical device having an electro-optical response stabilised as a function of time and modulation frequency.

The invention finds applications in an optical phase modulator, optical intensity modulator of the Mach-Zehnder interferometer type. The invention also finds applications in an active directional coupler.

### STATE OF THE ART

In the above field, it is known to manufacture and use an electro-optical device integrated on a planar electro-optical substrate, the electro-optical device comprising an optical waveguide and an electrode system adapted to modulate a light beam propagating in the optical waveguide by applying an electrical voltage across the electrode system.

Different materials can be used for the manufacturing of integrated electro-optical devices. Lithium niobate (LiNbO₃), lithium tantalate (LiTaO₃) and lithium antimoniate (LiSbO₃) are materials particularly interesting because they exhibit an electro-optical Pockels effect. By placing electrodes near the integrated waveguide, it is possible to modulate the optical waveguide index and thus to modulate the phase of an optical signal propagating in the waveguide. In an integrated electro-optical device in which the electrodes are separated by about ten microns, applying a voltage of only a few volts is sufficient to generate an electric field and induce the desired phase modulation.

Various technologies for manufacturing electro-optical devices integrated on a lithium niobate substrate have been developed, such as diffusion of titanium (Ti) and Annealed Proton Exchange (APE).

The proton exchange technology includes a first step in which a birefringent lithium niobate crystal is placed in a bath of benzoic acid heated to a temperature of less than 250° C. (below the boiling temperature of benzoic acid), to replace the lithium ions (Li⁺) by protons (or ions H⁺) from the surface exposed to the acid bath.

The Proton Exchange (PE) operation causes the formation of a layer 3 modified by proton exchange extending over the zone exposed to the acid from the substrate surface 2 down to a shallow depth P3 into the substrate 1 (see FIG. 1). The layer 3 has an optical refractive index difference of the order of 0.1 with the substrate. The refractive index profile of the layer 3 is step-shaped in the X-and Z-directions. The layer 3 is laterally limited to a width W3 generally between 1 μm and 10 μm. The depth P3 is here less than or equal to 500 nm. Indeed, the temperature being low, the proton exchange phenomenon cannot diffuse very far into the substrate.

This first step is followed by a thermal annealing step at a temperature of less than 500° C. During the annealing step, the temperature is higher, the protons, or hydrogen ions, of the layer 3 modified by proton exchange can exchange with the lithium ions in a diffusion area 4 about the initial location of the layer 3. The annealing makes it possible to create a gradient of refractive index in the diffusion area 4 under the crystal surface and hence to form an optical waveguide 5. The diffusion area 4 extends into the substrate down to a deep depth P4, which may reach several microns, depending on the temperature and duration of the annealing (see FIG. 2). The diffusion area 4 has a width W4 greater than the width W3 of the layer 3 modified by proton exchange. The width W4 is generally comprised between 1 μm and 10 μm. The width W4, and respectively the depth P4, are here measured at the maximum of the refractive index gradient divided by the number e in the base of the natural logarithms (or exponential (−1)), in the Z-and X-directions respectively.

After the thermal annealing step, the manufacturing of the electro-optical device comprises a step of depositing a pair of electrodes. This pair of electrodes makes it possible to apply an electric field in the optical waveguide 5 in order to control the electro-optical device, for example for the electro-optical modulation of an optical wave propagating in the optical waveguide 5.

The proton exchange on a birefringent lithium niobate crystal has the effect of both increasing the extraordinary index of the crystal, which creates guidance for a wave polarised along the extraordinary axis of the crystal, and reducing the ordinary index of the crystal, so that a wave polarised along the ordinary axis is not guided.

In the electro-optical devices comprising an optical waveguide formed by proton exchange on lithium niobate, the usual configuration is an X-cut, with the X-axis of the uniaxial lithium niobate birefringent crystal perpendicular to the substrate surface, while the Y-and Z-axes of the crystal are parallel to the surface. The propagation direction of the waveguide is parallel to the Y-axis and the TE mode (transverse electric, i.e. electric field parallel to the substrate surface) is parallel to the Z-direction. In this case, the proton exchange optical waveguide guides only the TE polarisation state, the cross-polarised TM state (transverse magnetic, i.e.

magnetic field parallel to the substrate surface and therefore electric field perpendicular to the substrate surface) propagating freely in the substrate. The lithium niobate proton exchange technique therefore makes it possible to manufacture a polarizing waveguide on an integrated optical circuit. Electrodes arranged on either side of the optical waveguide 5 are used to apply an electric field parallel to the Z-axis in the optical waveguide 5.

Their also exist electro-optical devices comprising an optical waveguide formed by proton exchange on lithium niobate (or lithium tantalate or lithium antimoniate), along a Z-cut, with the X-axis of the uniaxial lithium niobate birefringent crystal perpendicular to the substrate surface, while the X-and Y-axes of the crystal are parallel to the surface. The propagation direction of the waveguide is parallel to the Y-axis and the TE mode (transverse electric, i.e. electric field parallel to the substrate surface) is parallel to the Z-direction. One electrode covers the waveguide whereas the other electrode is arranged near the waveguide and on an opposite face of the substrate. These electrodes are used to apply an electric field parallel to the Z-axis in the optical waveguide 5. Moreover, in this case, the metal electrode covering the waveguide absorbs the TM mode of the electro-magnetic wave propagating in the optical waveguide 5, whereas it transmits the TE mode parallel to the Z-axis.

However, the behaviour of the integrated electro-optical devices manufactured by APE is degraded in particular conditions of use such as vacuum and/or temperature. For example, a phase electro-optical modulator manufactured by APE has a transfer function defined by the ratio between a voltage Vₘ applied to the terminals of the electrodes of the modulator and the optical phase-shift Φₘ induced, with Vₘ/Φₘ=V_{π}/π where the signal V_{π} is also called half-wave (V_{π}). Now this signal V_{π} fluctuates with the environment, in particular with the temperature and/or the vacuum.

Moreover, the low-frequency (between 100 Hz and 1 kHz) and very low-frequency (between 0.0 Hz and 100 Hz) response of an electro-optical device manufactured by APE is assimilated in certain applications to a slow drift of the operating points or measurable hysteresis in the transfer function of the electro-optical device.

Different solutions to the time drift of an integrated optical phase modulator have already been proposed. For example, the patent U.S. Pat. No. 8,463,081 proposes to combine in series an optical waveguide portion formed by diffusion titanium and another optical waveguide portion formed by APE, the two portions having temporal drifts of opposite signs. However, the compensation is not perfect but depends on the temperature and frequency of the signal applied at low and very low frequency.

One of the objects of the invention is to propose a mean for stabilizing the electro-optical response of an integrated electro-optical device, as a function of time and/or frequency of the modulation signal applied to the electrodes of such an integrated electro-optical device. It is desirable to reduce the slow drift of the operating points at low and very low frequencies. It is also desirable to suppress or limit the hysteresis of the transfer function of such an integrated electro-optical device. In particular, in an electro-optical phase modulator based on an integrated electro-optical device, it is desirable to reduce the fluctuations of the signal Vat with the environment, in particular with the temperature and/or the vacuum.

Another object of the invention is to propose a simple method for manufacturing such an integrated electro-optical device having an instantaneous electro-optical response, stable over time and/or as a function of the electrical modulation frequency, and independent on the ambient variations of temperature and/or pressure.

### DISCLOSURE OF THE INVENTION

In this context, the present invention proposes a method for manufacturing an electro-optical device.

More particularly, it is proposed according to the invention a method for manufacturing an electro-optical device comprising the following steps: manufacturing an optical waveguide in an electro-optical substrate by annealed proton exchange comprising the steps of: a) exposing an area of a surface of the substrate to a source of protons so as to create in the substrate a layer modified by proton exchange, said layer extending over said area from the substrate surface down to a shallow depth (P3) into the substrate, and b) thermally annealing the substrate in order to diffuse hydrogen ions from said layer to a diffusion area extending in the substrate around said layer down to a deep depth (P4), in order to create an optical waveguide in the diffusion layer; and depositing a pair of electrodes, the optical waveguide extending longitudinally between said pair of electrodes.

According to the invention, the method includes, after the thermal annealing step, a step of surface machining from the surface of at least part of the substrate in an area of the optical waveguide corresponding to a residue of said layer to form a machined area located at least partly between said pair of electrodes, over a depth P of the order of the shallow depth of the layer modified by proton exchange.

Therefore, the machining step makes it possible to remove at least partially a residue from the layer modified by proton exchange, whose electro-optical properties are damaged by the proton exchange. The removal of this residue makes it possible to reduce or even suppress time and/or frequency drifts of the electro-optical device, when an electrical voltage is applied between the electrode terminals.

Other non-limiting and advantageous features of the system according to the invention, taken individually or according to all the technically possible combinations, are the following:
the machined area extends down to a depth P, the depth P being deeper than or equal to 0.02*P3 and shallower than or equal to 1.10*P3, where P3 is the shallow depth of the layer modified by proton exchange before thermal annealing;
the machined area extends over at least part of a surface of deposition of said pair of electrodes;
the machined area extends over the whole width of the substrate taken transversally to a longitudinal direction of the optical waveguide;
the machined area is limited to an area of the waveguide between said pair of electrodes;
the machining step is adapted to form several machined areas arranged in series along a longitudinal direction of the optical waveguide, said several machined areas being located at least partly between said pair of electrodes;
the machined area extends over the whole surface of the substrate;
the machining step is carried out by wet etching, plasma etching, laser, lapping or mechanical polishing;
the method comprises a step of depositing a dielectric layer, the dielectric layer being arranged on the machined area at the surface of the substrate and/or between the substrate and at least one electrode of the pair of electrodes.

The invention also relates to an electro-optical device obtained according to any one of the embodiments described.

In particular, the invention relates to such an electro-optical device, used in an electro-optical phase modulator, an optical intensity modulator, a Mach-Zehnder interferometer and/or an active directional coupler with evanescent waves.

Obviously, the different features, alternatives and embodiments of the invention can be associated with each other according to various combinations, insofar as they are not incompatible or exclusive with respect to each other.

### BRIEF DESCRIPTION OF THE DRAWINGS

Moreover, various other features of the invention emerge from the appended description made with reference to the drawings that illustrate non-limiting embodiments of the invention, and wherein:

FIG. 1 is a cross-sectional view of an electro-optical substrate inside which is formed a layer modified by proton exchange before annealing;

FIG. 2 is a cross-sectional view of the electro-optical substrate after annealing to form a diffusion area;

FIG. 3 is a cross-sectional view of an integrated electro-optical device comprising an optical waveguide formed by APE and electrodes;

FIG. 4 is a graph schematically illustrating the response of an electro-optical modulator manufactured by APE as a function of the frequency, according to the prior art (solid line) and according to the present disclosure (dashed line);

FIG. 5 is a graph schematically illustrating the half-wave voltage, characteristic of the transfer function of an electro-optical modulator manufactured by APE as a function of the frequency, according to the prior art (solid line) and according to the present disclosure (dashed line);

FIG. 6 is a graph schematically illustrating, on the left, the voltage applied to the terminals of an electro-optical modulator manufactured by APE as a function of time, and on the right, an example of phase-shift produced respectively according to the prior art (solid line) and according to the present disclosure (dashed line);

FIG. 7 is a top view of an integrated electro-optical device comprising an optical waveguide formed by APE, electrodes, and a machined area according to a first example;

FIG. 8 is a top view of an integrated electro-optical device comprising an optical waveguide formed by APE, electrodes, and a machined area according to a second example;

FIG. 9 is a cross-sectional view of an integrated electro-optical device according to the first or the second example;

FIG. 10 is a top view of an integrated electro-optical device comprising an optical waveguide formed by APE, electrodes, and a machined area according to a third example;

FIG. 11 is a top view of an integrated electro-optical device comprising an optical waveguide formed by APE, electrodes, and a machined area according to a fourth example;

FIG. 12 is a top view of an integrated electro-optical device comprising an optical waveguide formed by APE, electrodes, and a machined area according to a fifth example;

FIG. 13 is a top view of an integrated electro-optical device comprising an optical waveguide formed by APE, electrodes, and a machined area according to a sixth example;

FIG. 14 is a cross-sectional view of an integrated electro-optical device according to any one of the third to sixth examples;

FIG. 15 is a cross-sectional view of an integrated electro-optical device according to a variant of any one of the third to sixth examples;

FIG. 16 is a cross-sectional view of a variant of an integrated electro-optical device comprising an optical waveguide formed by APE and electrodes;

FIG. 17 is a cross-sectional view of another variant of an integrated electro-optical device comprising an optical waveguide formed by APE and electrodes.

It is to be noted that, in these figures, the structural and/or functional elements common to the different alternatives can have the same references numbers.

### DETAILED DESCRIPTION

FIG. 3 schematically shows an integrated electro-optical device in cross-sectional view, i.e. perpendicular to the surface 2 of the electro-optical substrate 1 and transversely to a longitudinal direction of the optical waveguide 5. The integrated electro-optical device comprises an optical waveguide 5 formed by APE and electrodes 6, 7.

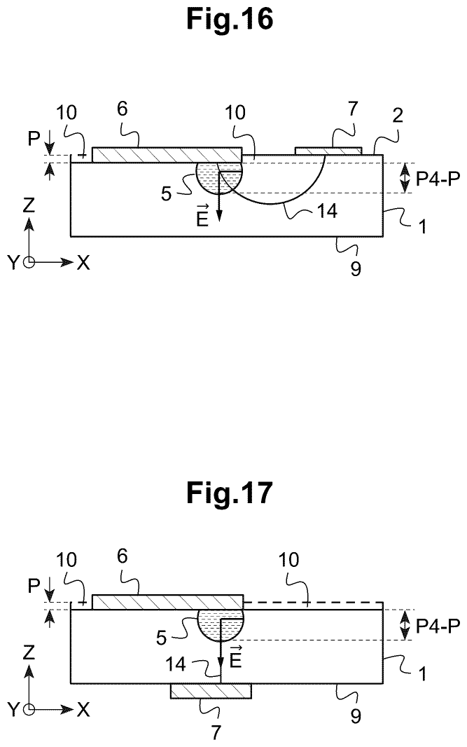

The electro-optical substrate 1 is for electro-optical a substrate made of lithium niobate (LiNbO₃). As a variant, the substrate 1 is a substrate made of lithium tantalate (LiTaO₃) or lithium antimonate (LiSbO₃). By way of non-limiting example, the substrate is in a X-cut configuration, the X-axis of the crystal being perpendicular to the substrate surface, while the Y-and Z-axes of the crystal are parallel to the surface, the Y-axis being parallel to the propagation direction of the optical waveguide. As a variant, the substrate is in a Z-cut configuration, the Z-axis of the crystal being perpendicular to the substrate surface, while the X-and Y-axes of the crystal are parallel to the surface, the Y-axis being parallel to the propagation direction of the optical waveguide (see FIGS. 16-17).

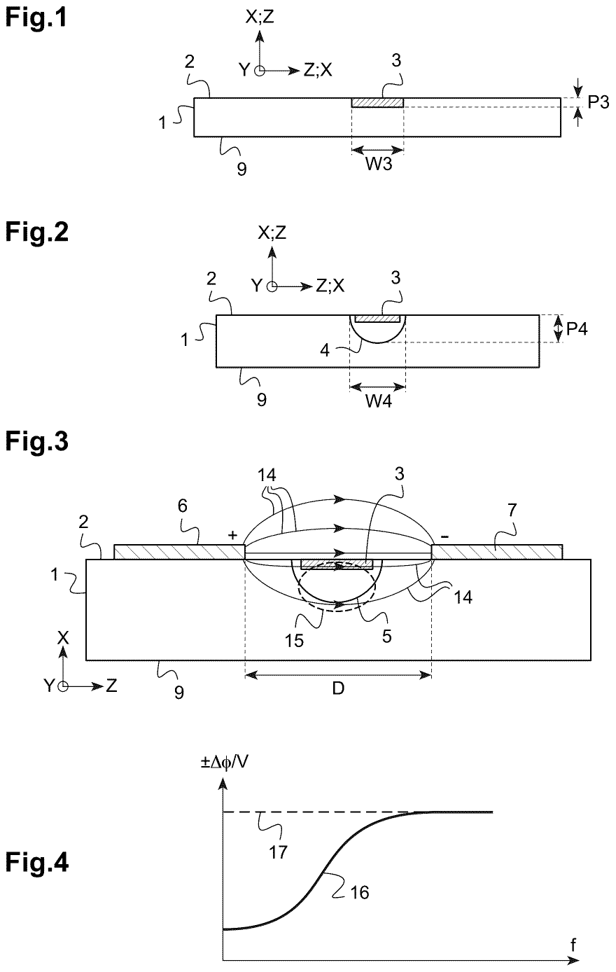

As described in connexion with FIGS. 1 and 2, a layer 3 modified by proton exchange is formed in the substrate 1. During thermal annealing, a diffusion area 4 extends into the substrate 1 around the initial location of the layer 3. The diffusion area 4 has a gradient of refractive index that makes is possible to form an optical waveguide 5. The optical waveguide 5 is limited by the index gradient and by the surface 2 of the surface 1. The width W4 of the optical waveguide 5 is generally comprised between 1 micrometre (μm) and 10 micrometres (μm). The optical waveguide 5 extends for example longitudinally along the Y-direction. As known, the optical waveguide 5 can be rectilinear or have a curvature and/or a junction with several branches, for example a two-branch Y-junction. The optical waveguide 5 is adapted to guide a single-mode optical wave so that it can propagate along a longitudinal direction of the optical waveguide 5, for example here along the Y-axis. In FIG. 3 is schematically shown the spatial extent of the fundamental mode 15 of an optical wave propagating in the optical waveguide 5.

The electro-optical device illustrated in FIG. 3 is in the X-cut and Y-propagation configuration. The integrated electro-optical device comprises a system of electrodes comprising at least one pair of conductive electrodes 6, 7. The electrode 6 is deposited on one side of the optical waveguide 5 and the electrode 7 is deposited on an opposite side of the optical waveguide 5. The pair of electrodes 6, 7 is generally deposited on the surface 2 of the substrate 1.

As a variant, a dielectric layer 24, for example silicon dioxide (SiO₂) or silicon nitride (SIN), is deposited between the surface 2 of the substrate 1 and each electrode 6, 7. The thickness of the dielectric layer 24 is e.g. between 100 nm and 2 μm. The dielectric layer 24 acts as a protection for the surface of the optical waveguide 5. The dielectric layer 24 also makes it possible to isolate the optical wave from the metal electrodes, for example if the optical waveguide is very close or risk to be partly in contact with an electrode, in particular for very wide-band electrodes (operating in the range from 0 to several tens of GHz).

For the sake of clarity, we will consider a rectilinear optical waveguide 5 and a pair of rectilinear electrodes 6, 7. The optical waveguide 5 extends longitudinally between said pair of electrodes 6, 7. The distance between the two electrodes 6, 7 is generally longer than or equal to the width W4 of the optical waveguide 5. For example, the distance D between the two electrodes 6, 7 is between 1 micrometre (μm) and 10 μm. The length L6 of the electrodes in the Y-direction is generally between a few millimetres and up to several centimetres. The electrodes have the same width or may have a different width. The optical waveguide 5 is centred or not between the two electrodes 6, 7. Optionally, another electrode is placed on the rear face 9 of the substrate 1, i.e. the face opposite to the front face 2 where the optical waveguide is formed by APE.

In relation with FIG. 3, the electro-optical operation of the integrated electro-optical device will now be explained. An electrical voltage is applied to the terminals of the pair of electrodes 6, 7. For example, a positive voltage is applied to the electrode 6 and a negative voltage is applied to the electrode 7. As a variant, one of the two electrodes is grounded. Lines 14 of electric field E appear between the pair of electrodes 6, 7. In particular, lines 14 of the electric field E oriented parallel to the Z-axis transverse to the optical waveguide 5. In a known manner, the electrical voltage modulation applied between the electrodes 6, 7 makes it possible to modulate the optical phase-shift of an optical wave propagating in the optical waveguide 5.

However, the electro-optical operation of the electro-optical device can exhibit some drift, illustrated in FIGS. 4 to 6.

In FIG. 4 is schematically shown in solid line a curve 16 of response of an electro-optical phase modulator manufactured by APE as a function of the frequency according to the prior art. More precisely, the curve 16 shows the ratio between the optical phase-shift ΔΦ induced in the optical wave propagating in the optical waveguide 5 and the applied voltage V as a function of the modulation frequency f. At high frequency, for example, above 1 kHz, the ratio ±ΔΦ is constant. On the other hand, at low frequency and very low frequency, the ratio ±ΔΦ decreases drastically. The response of the electro-optical phase modulator manufactured by APE according to the prior art depends on the modulation frequency, which is not desirable.

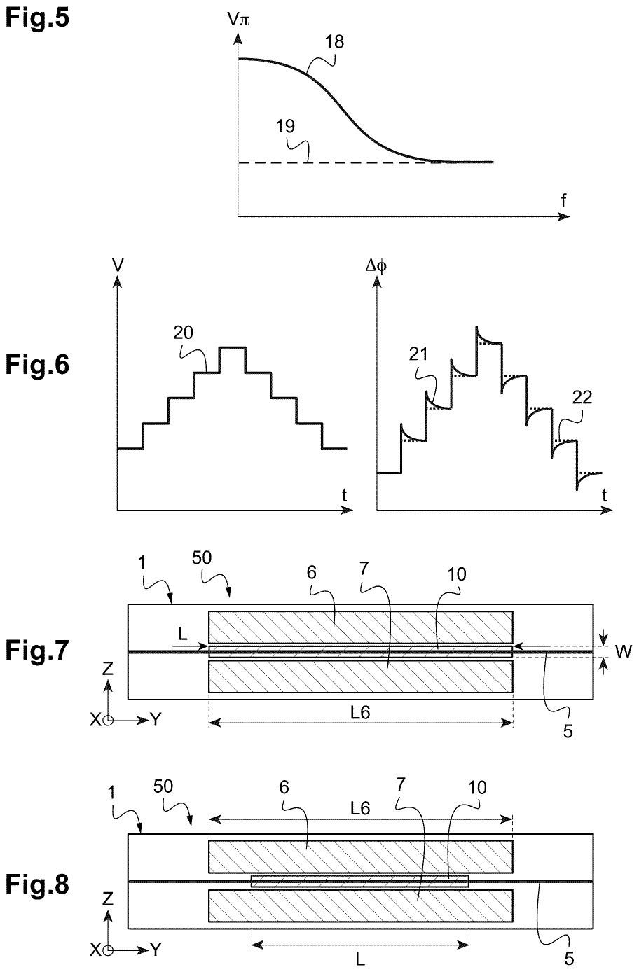

In FIG. 5 is schematically shown in solid line a curve 18 of half-wave voltage (or signal V_{π}) of an electro-optical phase or intensity modulator manufactured by APE as a function of the frequency, according to the prior art. More precisely, the curve 18 represents the signal Vat as a function of the modulation frequency f of the voltage applied to the terminals of the electrodes 6, 7. At high frequency, the signal V_{π} is constant. On the other hand, at low frequency and very low frequency, the signal V_{π} increases strongly. This curve 18 also indicates that the response of the electro-optical phase or intensity modulator manufacture by APE according to the prior art depends unfavourably on the modulation frequency f.

In FIG. 6, on the left, is shown a curve 20 of voltage V applied between the electrodes 6, 7 as a function of time. The voltage V increased gradually in stages, then decreases gradually, also in stages. In FIG. 6 is shown, on the right, a curve 21 of the phase-shift ΔΦ induced in the optical wave propagating in the optical waveguide 5 as a function of time, i.e. as a function of the applied voltage values V. The induced optical phase-shift curve 21 shows, for example, a negative exponential step as the voltage increases and a positive exponential step as the voltage decreases. In all the cases, at each step up or down, a stable induced phase-shift value is reached only after a period ranging from a millisecond to several hours and even longer.

It follows from the present disclosure that these slow drifts of the operating point of an electro-optical modulator as a function of time and/or modulation frequency can be greatly reduced by machining part of the substrate in an area of the optical waveguide 5 over a shallow depth corresponding to a residue of the layer 3 modified by proton exchange, located between the pair of electrodes 6, 7. As schematically illustrated in FIG. 3, the residue of the layer 3 modified by proton exchange extends from the substrate surface 2 down to a shallow depth in the optical waveguide 5, and perpendicularly to the longitudinal axis of the optical waveguide.

Without being bound by a theory, a physical interpretation is that during the proton exchange step, part of the lithium ions of the substrate 1, for example lithium niobate ions, is substituted by protons or H+ions to form the layer 3 modified by proton exchange. In cross-section, along the X-axis, the layer 3 modified by proton exchange exhibits a step-shaped step of optical refractive index down to depth P3. The substitution rate in the layer 3 may reach 60% or more of ions H⁺. It results therefrom that the crystalline structure of the layer 3 modified by proton exchange is degraded compared with the crystalline structure of the substrate 1 around the initial place of the layer 3 modified by proton exchange. In the area of the layer 3, the high rate of ion exchange leads to a local loss of the electro-optical properties of lithium niobate, necessary to any electro-optical modulation. During the step of thermal annealing at less than 500° C., the diffusion area 4, which forms the optical waveguide 5, extends in the substrate 1. During the thermal annealing, ions H+coming from the layer 3 are exchanged with lithium ions at greater depths, for example down to a depth of several microns depending on the temperature and duration of the annealing. The annealing makes it possible to obtain a gradient of optical refractive index in the substrate and hence to form an optical waveguide 5. In cross-section, along the X-axis, the diffusion area 4 has generally a profile of optical refractive index comparable to a semi-Gaussian. The depth P4 corresponds to the maximum divided by the number e in the base of the natural logarithms (or exponential (−1)) of this semi-Gaussian profile along X-axis. Similarly, the width W4 of the optical waveguide 5 corresponds to the maximum divided by the number e of this profile along the Z-axis. During the thermal annealing, the ion substitution rate in the diffusion area is lower, generally less than 15%. This low lithium ion substitution rate makes it possible to keep the crystal electro-optical properties. Following the thermal annealing, the low lithium ion substitution rate in the area corresponding to the location of the layer 3 modified by proton exchange has decreased.

Nevertheless, the crystalline structure at the location of the layer 3 modified by proton exchange remains degraded. The electro-optical device conventionally manufactured by APE has different crystalline properties in the substrate 1, in the diffusion area 4 and in the area corresponding to the layer 3 modified by proton exchange.

As illustrated in FIG. 3, the lines 14 of electric field not only pass through the diffusion area 4 but also an area under the surface of the substrate that correspond to a residue of the layer 3 modified by proton exchange. The electro-optical response of the electro-optical device depends not only on the electro-optical properties of the diffusion area 4 but also on the area corresponding to the location of the layer 3 modified by proton exchange. The crystalline degradation of the area of the layer 3 leads to an increase of its electrical conductivity when the electro-optical device so manufactured is placed at a hot temperature, for example about 50° C., this effect being accelerated and amplified when the temperature increases and when the electro-optical device is placed in hot vacuum.

The present disclosure proposes an additional step in the method for manufacturing an electro-optical device by APE, this additional step, after the thermal annealing step, comprising the machining of at least part of the optical waveguide 5 over a shallow depth corresponding to a residue of the layer 3 in an area located or intended to be located between the pair of electrodes 6, 7, so as to reduce or eliminate the residue of the layer 3 in the machined area. The depth P of the machined area is of the order of the shallow depth P3 of the layer 3 modified by proton exchange. In practice, the depth P can be less than, equal to or slightly greater than the shallow depth P3. For example, the depth P of the machined area is such that: 0.02*P3≤P≤1.10*P3, and preferably 0.50*P3≤P≤1.10*P3 and even more preferably 0.90*P3≤P≤1.10*P3. For example, for a depth P3 of 500 nm, the depth P of the machined area is of about 500 nm +50 nm. The machining step is carried out on a shallow depth P to keep major part of the diffusion zone 4. The depth P of the machined area is always less than the depth P4 of the diffusion area 4 so as not to degrade the optical guiding properties of the optical waveguide 5.

Preferably, the depth P of the machined area is less than 20-25% of the depth P4 of the diffusion area 4.

This step of machining the residue of said layer 3 can be carried out by various techniques: for example, mechanical machining such as lapping and/or polishing of the substrate surface or part of the substrate surface, surface ablation by laser pulses, wet etching or dry etching by plasma.

This step of machining the residue of said layer 3 can be carried out on a plate integrating several electro-optical devices manufactured in batches or on individual chips obtained for example after cutting of such a plate, each chip including a single electro-optical device. The step of machining the residue of said layer 3 can be carried out before or after the deposition of electrodes 6, 7 on a complete wafer or an individual chip. The step of machining the residue of said layer 3 can be carried out before or after transfer of a chip onto a base or into an electronic casing.

FIGS. 7 to 15 illustrate various exemplary embodiments of an electro-optical device according to the present disclosure. In FIGS. 7 to 15 are shown one machined area 10 or several machined areas 10, 11, 12 on each electro-optical device.

In FIG. 7, the electro-optical device 50 in top view includes an optical waveguide 5 formed by proton exchange annealed in an electro-optical substrate 1, a pair of electrodes 6, 7 arranged parallel to the two longitudinal sides of the optical waveguide 5. The electro-optical device includes a machined area 10 that extends here between the two electrodes 6, 7 over a width W and a length L. The width W of the machined area 10 is here less than or equal to the distance D between the two electrodes 6, 7. The length L of the machined area 10 is here equal to the length L6 of the electrodes 6, 7. The width W of the machined area 10 extends in alignment with the optical waveguide. The width W is taken perpendicular to the longitudinal axis of the optical waveguide 5 and parallel to the plane of the surface 2.

Advantageously, the width W is greater than or equal to the initial width W3 of the layer 3 modified by proton exchange. The machining of the residue of said layer 3 over this width W and over the whole length L6 of the electrodes 6, 7 makes it possible to fully eliminate the frequency and time drifts of the electro-optical device, as detailed hereinafter. In this configuration, the machining of the machined area 10 may be carried out before or after deposition of the electrodes. However, when this machining is carried out after the deposition of the electrodes, precautions must be taken to avoid damaging the electrodes 6, 7.

FIG. 8 shows a second example of an electro-optical device, according to a variant of FIG. 7. The machined area 10 has here a length L less than the length L6 of the electrodes 6, 7, for example such than 0.5*L6≤L<L6. The width W of the machined area 10 is here less than or equal to the distance D between the two electrodes 6, 7. This example illustrates certain configurations in which it is difficult to machine the area 10 over the whole length L6 of the electrodes. In this example, the machining of the machined area 10 may be carried out before or after deposition of the electrodes. In certain applications, the machining of the area 10 on a portion of the length of the electrodes is sufficient to limit the frequency and time drifts of the electro-optical device. In this case, the time or frequency drift phenomena are reduced proportionally to the machined area.

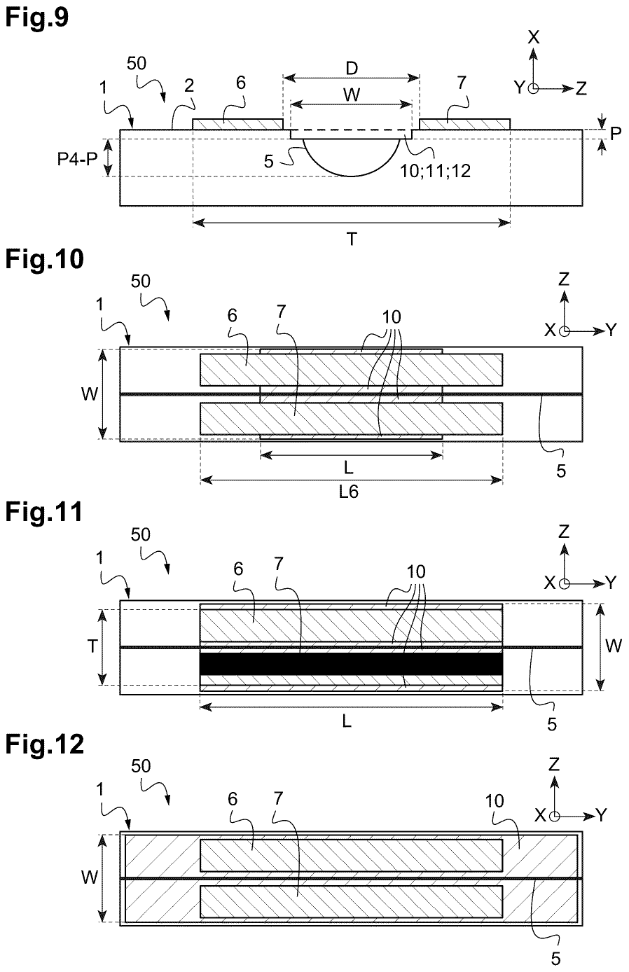

FIG. 9 is a cross-sectional view of the electro-optical device 50 of FIG. 7 or 8. The machined area 10 here corresponds to a recessed area in the substrate, under the initial surface 2 of the substrate and perpendicular to the longitudinal axis of the optical waveguide. The machined area 10 has a depth P. For example, the depth P is comprised between 10 nm and 550 nm for a depth P3 of 500 nm. The depth P of the machined area is less than, equal to or slightly greater than the shallow depth P3 of the layer 3 modified by proton exchange. In any case, the depth P of the machined area is less than the initial depth P4 of the diffusion area. Therefore, below the machined area between the electrodes 6, 7, the diffusion area 5 has a depth equal to P4-P. Generally, the remaining depth P4-P of the optical waveguide 5 is very greater than the depth P of the machined area. For example, the remaining depth P4-P of the optical waveguide 5 is greater than 75% of the initial depth of the optical waveguide 5 before machining.

The machined area 10 of the electro-optical device 50 of FIG. 7, 8 or 9 can be machined before or after the deposition of the electrodes 6, 7.

FIG. 10 shows a third example of an electro-optical device 50. The machined area 10 has here a length L less than the length L6 of the electrodes 6, 7. The width W of the machined area 10 is here greater than the total width T of the electrodes 6, 7. The width W of the machined area 10 is for example equal to the width of the substrate 1, which facilitates the use of mechanical machining. The machined area is then machined before the deposition of the electrodes.

FIG. 11 shows fourth example of an electro-optical device 50. The machined area 10 has here a length L equal to the length L6 of the electrodes 6, 7. The width W of the machined area 10 is here greater than the total width T of the electrodes 6, 7. The width W of the machined area 10 is for example equal to the width of the substrate 1, which facilitate the use of mechanical machining.

FIG. 12 shows a fifth example of an electro-optical device 50. The machined area 10 has here a length L greater than the length L6 of the electrodes 6, 7. The width W of the machined area 10 is here greater than the total width of the electrodes 6, 7. The machined area 10 here extends for example over the whole surface of the substrate 1. The machined area 10 can be shaped by etching, lapping and/or polishing of the surface so that the electro-optical device has a flat surface outside the electrodes. The machining of the whole surface makes it possible to ensure elimination of all the residual parts of the layer 3 modified by proton exchange. Moreover, the machining of the whole surface 2 is easy to implement because this is a full-plate machining without masking.

As a variant, the electro-optical device 50 illustrated in any one of FIGS. 10 to 12 includes a machined area or several disjoint machined areas located outside the electrodes 6, 7. For example, in FIG. 10 or 11, the device can also be shaped by forming a machined area located between the two electrodes 6, 7 and two machined areas outside the electrodes 6, 7. In this case, the machined area or disjointed machined areas can be shaped before or after deposition of the electrodes 6, 7.

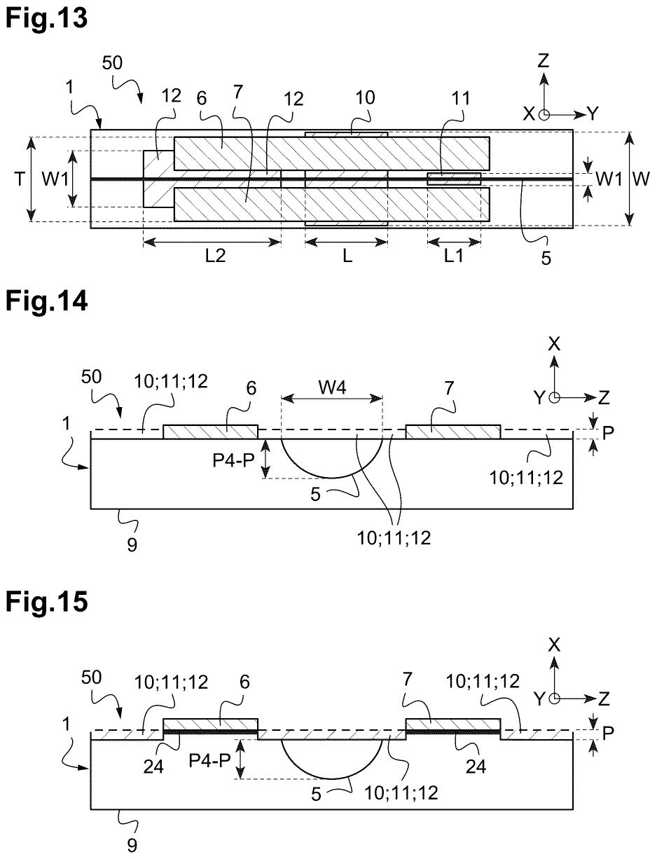

FIG. 13 shows a sixth example of electro-optical device 50 comprising several machined areas 10, 11, 12 arranged in series along the longitudinal direction Y of the optical waveguide 5. More precisely, a machined area 10 extends over a length L less than the length L6 of the electrodes 6, 7 and over a width W greater than the total width of the electrodes 6, 7, for example over the width of the substrate 1.

Another machined area 11 extends over a length L1 less than the length L6 of the electrodes 6, 7 and over a width W1 less than or equal to the distance D between the electrodes 6, 7. Still another machined area 12 extends longitudinally over a length L2 partly between the electrodes 6, 7 and partly beyond the electrodes 6, 7.

The machined area 12 extends transversely over a width W2 greater than the distance D between the electrodes 6, 7 and less than or equal to the total length T of the electrodes 6, 7. The machined areas 10, 11, 12 may be machined in a single operation, using the same machining technique, or be manufactured sequentially using different machining techniques as described above. For example, the machined area 11 can be shaped after the electrodes have been deposited, in the case where time or frequency drifts subsist, to still limit these drifts.

FIG. 14 shows a cross-sectional view of an electro-optical device 50 as illustrated for example in one of FIGS. 10 to 13. Advantageously, the machined area 10, 11 and/or 12 is shaped before the deposition of the electrodes 6, 7. The machined area 10, 11 and/or 12 is in this example machined over a width W greater than the total width T of the electrodes, and preferably over the whole width of the substrate 1. For example, the machined area(s) are here formed by removing a layer of thickness P over the whole width of the substrate after the thermal annealing step or before the electrode deposition step. In the cross-sectional view, it is observed that the machining of the surface has suppressed a layer of thickness P of the optical waveguide 5, where was located the residue of the layer 3 modified by proton exchange. Here again, below the machined area between the electrodes 6, 7, the diffusion area 5 has a depth equal to P4-P, which remains greater than 75% of the initial depth of the optical waveguide 5 before machining.

FIG. 15 shows a cross-sectional view of an example of electro-example device 50 as illustrated in one of FIGS. 10 to 13. Here, the machined area 10, 11 and/or 12 is shaped before or after the deposition of the electrodes 6, 7. The machined area 10, 11 and/or 12 is in this example shaped over a width W less than or equal to the distance D between the electrodes. Optionally, lateral areas are also machined outside the electrodes between the total width T and the substrate width. For example, the machined area(s) are here formed by removing a central strip of thickness P over the whole length or part of the length of the electrodes, and possibly two lateral strips after the thermal annealing step and before or after the electrode deposition step. In the cross-sectional view, it is observed that the machining of the surface has suppressed a layer of thickness P of the optical waveguide 5, where was located the residue of the layer 3 modified by proton exchange. After deposition of the electrodes 6, 7, the electro-optical device has a recess between the electrodes 6, 7 in the machined area 10. In this example, the electrodes 6, 7 are located at a height greater than P with respect to the optical waveguide.

Optionally, after the manufacturing of the machined area, the method includes an additional step of depositing a dielectric layer 24, for example silicon dioxide (SiO₂) or silicon nitride (SiN). The dielectric layer 24 is arranged at the substrate surface after machining, between teach electrode 6, 7 and the substrate 1. As a variant, the dielectric layer 24 extends not only below the electrodes, but over the whole surface of the substrate.

As an alternative or as a complement, the method includes another step of depositing a dielectric layer 24, for example silicon dioxide (SiO₂) or silicon nitride (SiN). The two electrodes 6, 7 are deposited on this dielectric layer 24. The dielectric layer 24 makes it possible to protect the surface of the optical waveguide 5. The dielectric layer 24 also makes it possible to isolate the optical wave circulating in the optical waveguide relative to metal electrodes.

The presence of a residue of the layer corresponding to the layer 3 modified by proton exchange after thermal annealing can be detected and measured by different characterization techniques such that: optical or contact profilometry, Raman spectrometry, secondary-ion mass spectrometry (SIMS), X-ray rocking curves, transverse electron microscopy (TEM), Fourier transform spectroscopy (FTIR) or UV ellipsometry. These techniques make it possible to evaluate the depth P of the machining to be carried out. The machining depth P is generally lower than 500 nm. The machining depth P can be checked by verifying the machined depth during manufacture or by measuring the surface conductivity before/after etching.

Moreover, the electro-optical operation of the device is checked after the manufacturing.

An integrated electro-optical device 50 is obtained, which contains at least one machined area 10, 11, 12 in the optical waveguide 5 over a shallow depth P, the machined area 10, 11, 12 being located at least partly between the pair of electrodes 6, 7. The machined area is adapted to suppress at least partly a residue of the layer 3 modified by proton exchange in an area located at least partly between said pair of electrodes 6, 7. However, the depth of the machined area in the optical waveguide is limited so as to maintain the optical guiding properties of the optical waveguide 5.

Preferably, the depth of the machined area in the optical waveguide is less than 25% of the initial depth of the optical waveguide 5 before machining. In certain embodiments, the machined area remains empty and may form a recess with respect to the substrate surface. In other embodiments, the machined area is at least partially filled with a dielectric layer, for example. Finally, in other embodiments, the machined area extends over the whole surface of the substrate, which has then the same surface relief as a non-machined electro-optical device.

The method also applies to an electro-optical device comprising an optical waveguide formed by proton exchange on lithium niobate (or lithium tantalate or lithium antimoniate), along a Z-cut, as illustrated in FIGS. 16-17. In this case, an electrode 6 is in contact with the optical waveguide 5. The other electrode 7 is arranged near the optical waveguide 5 on the same face of the electrode 6 (see FIG. 16) or on the opposite face 9 of the substrate 1 (see FIG. 17). In this Z-cut configuration, an electrical potential difference applied between the two electrodes generates an electric field E oriented along the Z-axis in the optical waveguide 5.

According the present disclosure, in Z-cut configuration, similarly to the X-cut configuration, after the thermal annealing step, at least part of the residue of the layer 3 is machined, in an area of the optical waveguide 5 intended to be placed in contact with the electrode 6, and between the pair of electrodes 6, 7, in order to reduce or eliminate the residue of the layer 3 in the machined area. The depth P of the machined area is of the order of the shallow depth P3 of the layer 3 modified by proton exchange. In practice, the depth P can be less than, equal to or slightly greater than the shallow depth P3. For example, the depth P of the machined area is such that: 0.02*P3≤P≤1.10*P3, and preferably 0.50*P3≤P≤1.10*P3 and even more preferably 0.90*P3≤P≤1.10*P3. For example, for a depth P3 of 500 nm, the depth P of the machined area is of about 500 nm±50 nm. The machining step is carried out on a shallow depth P to keep major part of the diffusion zone 4.

In the Z-cut configuration, the machining step is necessarily carried out before the step of depositing the electrode 6. The machining step may be carried out over the whole surface 2 of the substrate, after the thermal annealing step, in order to obtain a flat surface before deposition of the electrode 6, as illustrate for example in FIG. 17. As a variant, as illustrated in FIG. 16, the machining is applied on a surface limited in width and/or in length of the face 2 of the substrate, above the optical waveguide 5. The partial or extending machining over the whole surface can apply whether the electrode 7 is located on the same face 2 as the electrode 6 or on the opposite face 9.

An X-cut or Z-cut configuration electro-optical device is thus obtained, in which at least part of the residue of the layer 3 modified by proton exchange is removed in an area located or intended to be placed between the pair of electrodes 6,7.

In a non-intuitive way, this superficial machining, which can be limited locally to a small portion of the substrate between the pair of electrodes, makes it possible to obtain a great improvement of the electro-optical device response, whether it is as a function of time, temperature, pressure (for example, in a vacuum) or at low or very low modulation frequency.

In FIGS. 4 to 6 are schematically shown the technical effects obtained on an integrated electro-optical device obtained by annealed proton exchange according to the method of the present disclosure with a machining step.

In FIG. 4 is schematically shown in dashed line a curve 17 of response, as a function of the frequency, of an electro-optical phase modulator manufactured by APE and machined according to the present disclosure. It is observed that the ratio of the optical phase-shift ΔΦ induced on the applied voltage V remains constant at low frequency or very low frequency. The ratio ±ΔΦ/V is independent on the modulation frequency f, in particular at low frequency or very low frequency.

In FIG. 5 is schematically shown in dashed line a curve 19 of half-wave voltage (or signal V_{π}) of an electro-optical phase modulator manufactured by APE and machined according to the present disclosure. It is observed that the signal V_{π} remains constant at low frequency and very low frequency. The curve 19 of the signal V_{π} is independent of the modulation frequency f, in particular at low frequency and very low frequency.

In FIG. 6 is shown, on the right, a curve 22 of the optical phase-shift ΔΦ induced in the optical wave propagating in the optical waveguide 5 as a function of time, i.e. as a function of the applied voltage values V along the curve 20. On the induced optical phase-shift curve 22, instantaneous steps are observed when the voltage increases or when the voltage decreases. The optical phase-shift value desired instantaneously at each change of voltage value applied to the electrodes 6, 7 is thus obtained.

A possible interpretation of these improvements of the electro-optical response of the electro-optical device with a machine area according to the present disclosure is the following. The electrical conductivity of the degraded crystalline structure at the location of the layer 3 modified by proton exchange may vary as a function of the temperature or in hot vacuum, for example. As illustrated in FIG. 3, the fundamental mode 15 of the guided wave of the optical waveguide 5 extends to the substrate surface and partly covers the place where is located the residue of the layer 3 modified by proton exchange. When a voltage is applied between the electrodes 6, 7, the electric field lines 14 pass through the different areas that have different electrical conductivity: the substrate 1, the diffusion area 4 and the area in which is located a residue of the layer 3 modified by proton exchange. The physical properties of these areas are different. In particular, their conductivity varies differently depending on environmental conditions, in particular temperature and pressure. The increase in conductivity of the residue of layer 3 modified by proton exchange is different from that of the optical waveguide 5 and the substrate. The conductivity variation difference modifies the electro-optical covering and therefore the response as a function of the modulation frequency applied to the electrodes. The machining of the residue on a determined and shallow area of the substrate 1 between the electrodes 6, 7 allows the residue of layer 3 to be at least partially removed. This surface machining, over a depth P in the proportion indicated in detail hereinabove, does not disturb the guiding of the single-mode wave guiding in the optical waveguide 5.

The so-obtained electro-optical device advantageously finds applications in an electro-optical phase modulator, optical intensity modulator and/or a Mach-Zehnder interferometer. The so-obtained electro-optical device advantageously finds applications in an active directional coupler with evanescent waves, as for example an 2×2 active coupler on a lithium niobate substrate comprising electrodes arranged in the evanescent wave coupling zone.

1. A method for manufacturing an electro-optical device (50) comprising the following steps: manufacturing an optical waveguide (5) in an electro-optical substrate (1) by annealed proton exchange comprising the steps of: a) exposing an area of a surface (2) of the substrate (1) to a source of protons so as to create in the substrate a layer (3) modified by proton exchange, said layer (3) extending over said area from the substrate surface (2) down to a shallow depth (P3) into the substrate, and b) thermally annealing the substrate in order to diffuse hydrogen ions from said layer (3) to a diffusion area (4) extending in the substrate around said layer (3) down to a deep depth (P4), in order to create an optical waveguide (5) in the diffusion area (4); depositing a pair of electrodes (6, 7), the optical waveguide (5) extending longitudinally between said pair of electrodes (6, 7); wherein the method includes, after the thermal annealing step, a step of machining from the surface (2) at least part of the substrate in an area of the optical waveguide (5) corresponding to a residue of said layer (3) to form a machined area (10, 11, 12) located at least partly between said pair of electrodes (6, 7), over a depth P of the order of the shallow depth (P3) of the layer (3) modified by proton exchange.

2. The method according to claim 1, wherein the machined area (10, 11, 12) extends into the substrate (1) down to a depth P, the depth P being greater than or equal to 0.02*P3 and less than or equal to 1.10*P3.

3. The method according to claim 1, wherein the machined area (10, 12) extends over at least part of a surface of deposition of said pair of electrodes.

4. The method according to claim 1, wherein the machined area (10, 11, 12) extends over the whole width of the substrate (1) taken transversely to a longitudinal direction of the optical waveguide (5).

5. The method according to claim 1, wherein the machined area (10) is limited to an area of the waveguide (5) between said pair of electrodes (6, 7).

6. The method according to claim 1, wherein the machining step is adapted to form several machined areas (10, 11, 12) arranged in series along a longitudinal direction of the optical waveguide (5), said several machined areas (10, 11, 12) being located at least partly between said pair of electrodes (6, 7).

7. The method according to claim 1, wherein the machined area (10) extends over the whole surface of the substrate.

8. The method according to claim 1, wherein the machining step is carried out by wet etching, plasma etching, laser, lapping or mechanical polishing.

9. The method according to claim 1, comprising a step of depositing a dielectric layer (24), the dielectric layer (24) being arranged on the machined area (10) at the surface of the substrate (1) and/or between the substrate and at least one electrode of the pair of electrodes (6, 7).

10. An electro-optical device (50) obtained according to the method of claim 1.

11. The electro-optical device according to claim 10, used in an electro-optical phase modulator, an optical intensity modulator, a Mach-Zehnder interferometer and/or an active directional coupler with evanescent waves.

12. The method according to claim 2, wherein the machined area (10, 12) extends over at least part of a surface of deposition of said pair of electrodes.

13. The method according to claim 2, wherein the machined area (10, 11, 12) extends over the whole width of the substrate (1) taken transversely to a longitudinal direction of the optical waveguide (5).

14. The method according to claim 2, wherein the machined area (10) is limited to an area of the waveguide (5) between said pair of electrodes (6, 7).

15. The method according to claim 2, wherein the machining step is adapted to form several machined areas (10, 11, 12) arranged in series along a longitudinal direction of the optical waveguide (5), said several machined areas (10, 11, 12) being located at least partly between said pair of electrodes (6, 7).

16. The method according to claim 3, wherein the machining step is adapted to form several machined areas (10, 11, 12) arranged in series along a longitudinal direction of the optical waveguide (5), said several machined areas (10, 11, 12) being located at least partly between said pair of electrodes (6, 7).

17. The method according to claim 2, wherein the machining step is carried out by wet etching, plasma etching, laser, lapping or mechanical polishing.

18. The method according to claim 3, wherein the machining step is carried out by wet etching, plasma etching, laser, lapping or mechanical polishing.

19. The method according to claim 2, comprising a step of depositing a dielectric layer (24), the dielectric layer (24) being arranged on the machined area (10) at the surface of the substrate (1) and/or between the substrate and at least one electrode of the pair of electrodes (6, 7).

20. The method according to claim 3, comprising a step of depositing a dielectric layer (24), the dielectric layer (24) being arranged on the machined area (10) at the surface of the substrate (1) and/or between the substrate and at least one electrode of the pair of electrodes (6, 7).
